(19) United States
(12) Patent Application Publication
(10) Pub. No.: US 2014/0346198 A1
(43) Pub. Date: Nov. 27, 2014

(54) LIQUID POUR METERING DEVICE

(71) Applicant: Shane Bond, Castleconnell (IE)

(72) Inventor: Shane Bond, Castleconnell (IE)

(73) Assignee: Precisionflo Limited, Castleconnell, Limerick (IE)

(21) Appl. No.: 14/128,288

(22) PCT Filed: Jun. 22, 2012
(86) PCT No.: PCT/EP2012/062118

§ 371 Date: Jul. 7, 2014

(30) Foreign Application Priority Data
Jun. 23, 2011 (GB) 1110600.2

(51) Int. Cl. B67D 3/00

(52) U.S. Cl. CPC B67D 3/0041; B67D 3/0077; B67D 3/0051
USPC 222/641; 222/36

(57) ABSTRACT

This invention relates to a liquid pour metering device (21, 51, 81, 101) as well as a system (111) and method of monitoring dispensing of liquid from a liquid container (113). The device (21, 51) comprises a body defining a liquid passageway (7) having an inlet (9) at one end and an outlet (11) at the other end, the liquid passageway having a mechanical portion controller (1) therein comprising a ball bearing (13) moveable along at least portion of the length of the liquid passageway. There is provided a motion sensor (23) to detect when a pour operation has commenced and a ball bearing sensor (25) operable to detect the end of the pour operation. There is further provided a timer (29) and a transmitter (31) for transmitting data relating to the length of time required to perform the pour operation. By having such a device, it is possible to accurately determine whether the pour is a true pour, a non-pour or an overpour using a mechanical portion controller (1) in a liquid pour metering system thereby obviating the problems of inaccuracies and power requirements of the known systems. The recorded sales may also be compared to registered sales to highlight discrepancies and prevent theft.

### INTRODUCTION

This invention relates to a liquid pour metering device, a system for monitoring dispensing of liquid from a plurality of liquid containers and a method of monitoring dispensing of liquid from a liquid container.

There are a number of liquid portion controllers available on the market today. These liquid portion controllers are commonly used to dispense a measure, otherwise referred to as a “shot”, of an alcoholic beverage from a bottle into a glass. The liquid portion controllers allow a fixed amount of alcohol to be dispensed from the bottle and will stem the flow of liquid from the bottle once the desired amount has been dispensed. Accordingly, the portion controllers enable the bartender to dispense a fixed amount of liquid from a bottle with the minimum amount of care and coordination required. If the bartender becomes distracted while pouring the beverage, they will not “overpour” the beverage as the liquid portion controller will cut off the flow of liquid once the correct amount has been dispensed. Furthermore, the bartender will not have a tendency to “underpour” the beverage as they know to continue pouring until the liquid portion controller stems the flow of liquid, thereby obviating the possibility of disputes with customers.

The liquid portion controllers have been useful for both customers and bar owners alike. The liquid portion controllers are of considerable benefit to the customers by promoting responsible drinking through ensuring that the customers know precisely how much alcohol they are consuming. Furthermore, the liquid portion controllers have been beneficial to bar owners by allowing them to maximise their profits by reducing the number of overpours and allowing the bar owners to optimise the number of shots per bottle.

The liquid portion controllers can be categorised in two distinct groups, electronic portion controllers and mechanical portion controllers. Electronic portion controllers suffer from the disadvantage that they are relatively power-hungry devices and require regular charging which is inconvenient and time consuming to do. If the battery power runs out, the electronic liquid portion controllers typically will prevent further pouring of liquid from the bottle until such time that the battery is recharged. This is highly undesirable as it will inevitably cause a delay in serving a customer with their desired beverage. Mechanical portion controllers do not suffer from the shortcomings of the electronic portion controllers related to battery power and are more reliable devices without any interruption in service.

Various attempts have been made to integrate the liquid portion controllers into a liquid pour metering system. Liquid pour metering systems comprise a monitoring computer in communication with a plurality of liquid pour metering devices, each of which incorporate a liquid portion controller. The monitoring computer receives a communication from the liquid pour metering devices each time liquid is dispensed from the bottle with which the liquid pour metering device is associated. Liquid pour metering systems are becoming increasingly popular as they allow the bar owners to carefully and accurately monitor the amount of liquid being dispensed from each of the bottles stocked by them. The bar owners can use this information to monitor the performance of their employees and can also use the information for stock control and other purposes.

It will be clear to the skilled addressee that the electronic portion controllers lend themselves to such liquid pour metering systems however the communications required represent a further drain on the battery power of the electronic portion controller thereby further exacerbating the problems with the electronic portion controllers. Mechanical portion controllers do not immediately lend themselves to such liquid pour metering systems due in part to the fact that additional electronics such as tilt sensors, communications modules and a power supply for the electronics must be provided. Furthermore, the known embodiments of liquid pour metering systems with mechanical portion controllers are unable to determine whether or not a pour is a true pour. If the bottle is empty and is inverted, the mechanical portion controllers of the known liquid pour metering systems will still register this as a pour even though no alcohol has been dispensed. If the bottle is slowly inverted, thereby potentially resulting in the mechanical portion controller being “fooled” and additional liquid being dispensed from the bottle, the mechanical portion controllers of the known liquid pour metering systems will simply register this as a normal pour rather than a long slow pour which is potentially an overpour. With other prior art systems, if the bottle is held in an inverted configuration after the pour is completed the prior art systems will not be able to differentiate such a pour from a long slow pour.

It is an object of the present invention to provide a liquid pour metering device, a system for monitoring dispensing of liquid from a plurality of liquid containers and a method of monitoring dispensing of liquid from a liquid container that overcome at least some of the difficulties with the known devices, systems and methods.

### STATEMENTS OF INVENTION

According to the invention there is provided a liquid pour metering device comprising a body defining a liquid passageway having a liquid inlet at one end and a liquid outlet at the other end, the liquid passageway having a mechanical portion controller therein comprising a ball bearing moveable along at least portion of the length of the liquid passageway to and from a position blocking flow of liquid out of the liquid outlet and a position permitting flow of liquid out of the liquid outlet, characterized in that there is provided a motion sensor to detect when a pour operation has commenced, a ball bearing sensor mounted adjacent the liquid passageway operable to detect when the ball bearing is in the position blocking flow of liquid out of the liquid outlet indicating the end of the pour operation, a timer and a transmitter for transmitting data relating to the length of time required to perform the pour operation.

By having such a device, it will be possible to detect not simply that a pour has taken place, but also when the pour commenced, ceased and the time taken to complete the pour. By having this information, it will be possible to determine whether or not the pour was a true pour, a non-pour or an overpour. This will allow for a more accurate liquid pour metering system to be provided. Of particular note however is that this is achieved with a mechanical portion controller rather than an electronic portion controller and therefore the device will not have the same drain on the power supply as the known systems and devices. The system will be inexpensive to manufacture and operate and will require less frequent replacement or recharging of the device's power supply.

In one embodiment of the invention there is provided a liquid pour metering device in which the ball bearing sensor is an electronic ferrous detection sensor. This is seen as a particularly useful way of detecting when a pour operation has ceased as it is relatively reliable, inexpensive and is unobtrusive to the operation of the mechanical portion controller.

In one embodiment of the invention there is provided a liquid pour metering device in which the ball bearing sensor is a Magnasphere® ferrous proximity sensor.

In one embodiment of the invention there is provided a liquid pour metering device in which the ball bearing sensor is a capacitive sensor. This is seen as a useful alternative to the electronic ferrous detection sensor as the capacitive sensor will detect the presence of the ball bearing in its proximity.

In one embodiment of the invention there is provided a liquid pour metering device in which the mechanical portion controller is a two ball bearing mechanical controller.

In one embodiment of the invention there is provided a liquid pour metering device in which the mechanical portion controller is a three ball bearing mechanical controller. This is seen as a particularly preferred type of mechanical portion controller to use as it is reliable in operation and relatively inexpensive to produce.

In one embodiment of the invention there is provided a liquid pour metering device in which the motion sensor to detect when a pour operation has commenced comprises a tilt sensor.

In one embodiment of the invention there is provided a liquid pour monitoring system for monitoring dispensing of liquid from a plurality of liquid containers, at least some of the liquid containers having a liquid pour metering device mounted thereon, the system comprising a monitoring computer having a receiver to receive the data relating to the length of time required to perform the pour operation from each of the liquid pour metering devices and a processor to process the data.

By having such a system, the amount of liquid dispensed from each of the liquid containers can be monitored with ease and more accurately than was heretofore the case. Furthermore, the system will not suffer from the need to frequently recharge or replace the power supply in each of the liquid pour metering devices resulting in a more efficient and less time consuming system to operate.

In one embodiment of the invention there is provided a method of monitoring dispensing of liquid from a liquid container, the liquid container having a liquid pour metering device mounted thereon, the liquid pour metering device comprising a body defining a liquid passageway having a liquid inlet at one end and a liquid outlet at the other end, the liquid passageway having a mechanical portion controller therein comprising a ball bearing moveable along at least portion of the length of the liquid passageway to and from a position blocking flow of liquid out of the liquid outlet and hence out of the liquid container and a position permitting flow of liquid out of the liquid outlet and hence out of the liquid container, a motion sensor to detect when a pour operation has commenced, a ball bearing sensor mounted adjacent the liquid passageway operable to detect when the ball bearing is in the position blocking flow of liquid out of the liquid outlet indicating the end of the pour operation, a timer and a transmitter for transmitting data relating to the length of time required to perform the pour operation, the method comprising the steps of:
detecting with the motion sensor when a pour operation has commenced;
detecting with the ball bearing sensor when a pour operation has ceased;
determining the length of time between the pour operation commencing and the pour operation ceasing; and
thereafter determining whether or not the pour was a true pour.

By having such a method, it will be possible to determine whether or not the pour is a true pour. Furthermore, non-pours can be detected which was heretofore not possible using the know systems with mechanical portion controllers. The method according to the invention will provide a more accurate a reliable monitoring method.

In one embodiment of the invention there is provided a method further comprising the step of determining whether the pour was one of an overpour or a non-pour.

In one embodiment of the invention, there is provided a method further comprising the step of determining whether the pour was a short pour.

In one embodiment of the invention there is provided a method in which the step of detecting with the ball bearing sensor when a pour operation has ceased comprises using an electronic ferrous detection sensor to detect when the ball bearing is in the position in the liquid passageway blocking flow of liquid out of the liquid outlet.

In one embodiment of the invention there is provided a liquid pour metering device comprising a casing for mounting around a liquid pouring spout, the liquid pouring spout comprising a liquid passageway having a liquid inlet and a liquid outlet, and a mechanical portion controller comprising a ball bearing moveable along at least portion of the length of a liquid passageway in the spout to and from a position blocking flow of liquid out of the liquid outlet and a position permitting flow of liquid out of the liquid outlet, characterized in that the liquid pour metering device comprises, mounted in the casing, a motion sensor to detect when a pour operation has commenced, a ball bearing sensor for mounting adjacent the liquid passageway and operable to detect when the ball bearing is in the position in the liquid passageway blocking flow of liquid out of the liquid outlet indicating the end of the pour operation, a timer and a transmitter for transmitting data relating to the length of time required to perform the pour operation.

By having such a liquid pour metering device, the device may be retro-fitted to bottles with mechanical portion controllers already fitted thereto thereby allowing easy incorporation of many bottles into the liquid pour metering systems according to the invention with ease at the minimum expense.

In one embodiment of the invention the ball bearing sensor is an electronic ferrous detection sensor. In one embodiment of the invention the ball bearing sensor is a Magnasphere® ferrous proximity sensor. In one embodiment of the invention the ball bearing sensor is a capacitive sensor.

In one embodiment of the invention, the motion sensor to detect when a pour operation has commenced comprises a tilt sensor.

### DETAILED DESCRIPTION OF THE INVENTION

The invention will now be more clearly understood from the following description of some embodiments thereof given by way of example only with reference to the accompanying drawings, in which:

FIG. 1 is a side cross sectional view of a mechanical portion controller known in the art;

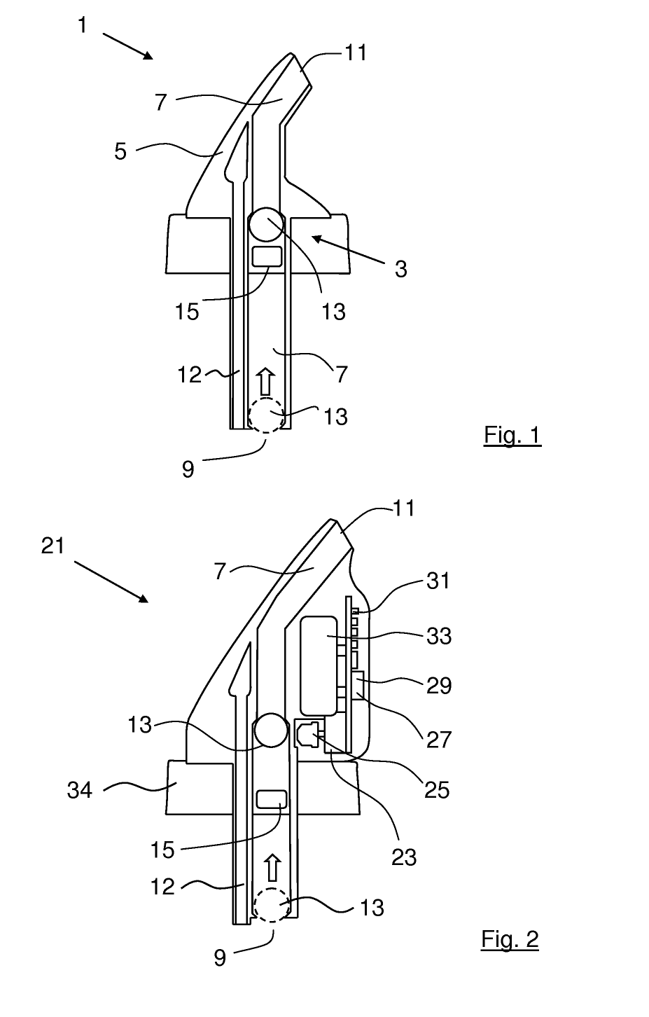

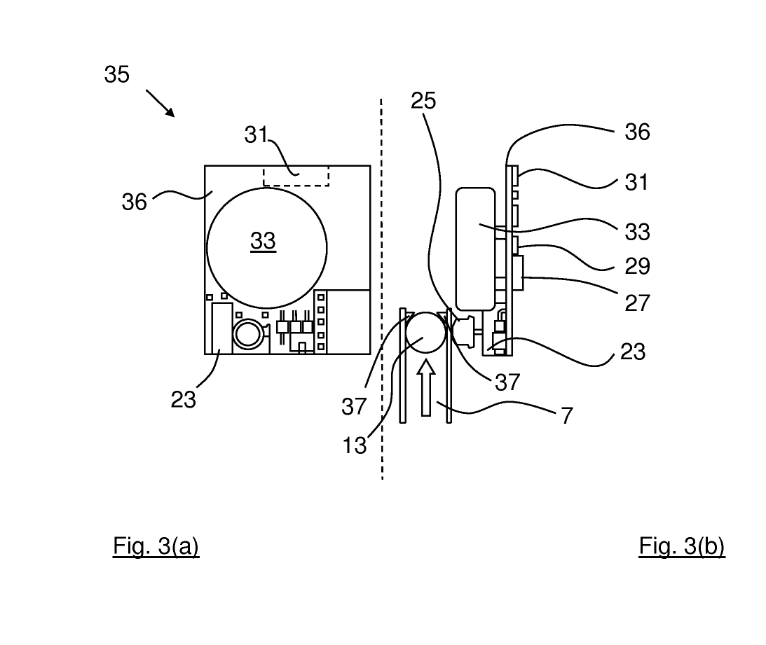

FIG. 2 is a side cross sectional view of a liquid pour metering device according to the present invention;

FIGS. 3(a) and 3(b) are diagrammatic representations of the electronic circuitry of the liquid pour metering device according to the invention;

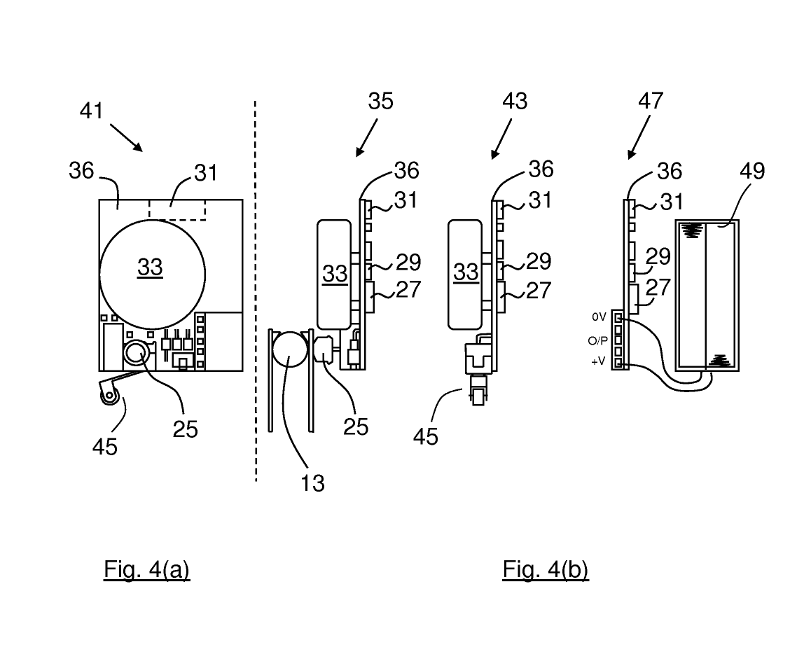

FIGS. 4(a) and 4(b) are diagrammatic representations of the electronic circuitry of an alternative embodiment of liquid pour metering device according to the invention;

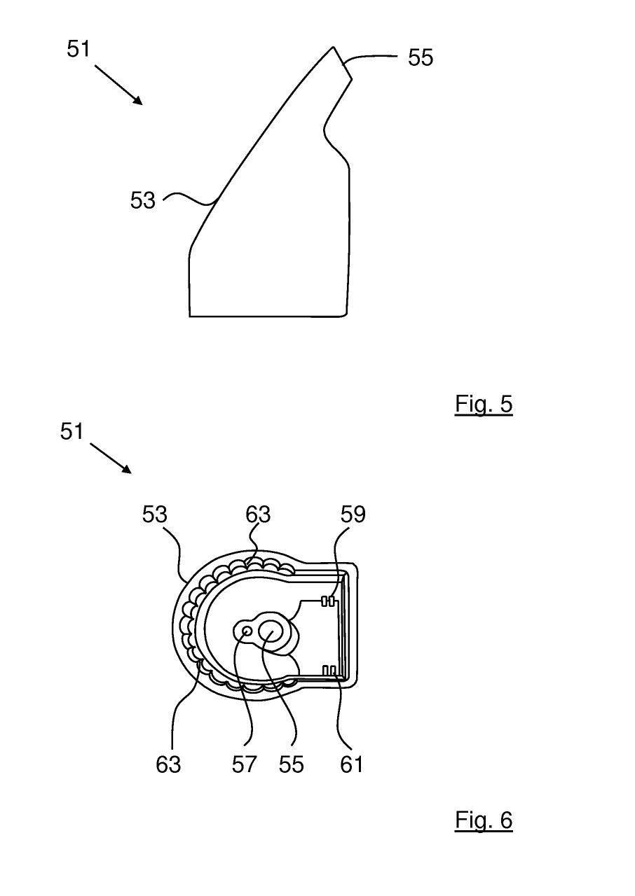

FIG. 5 is a side view of another embodiment of liquid pour metering device according to the present invention;

FIG. 6 is an underneath perspective view of the liquid pour metering device shown in FIG. 5;

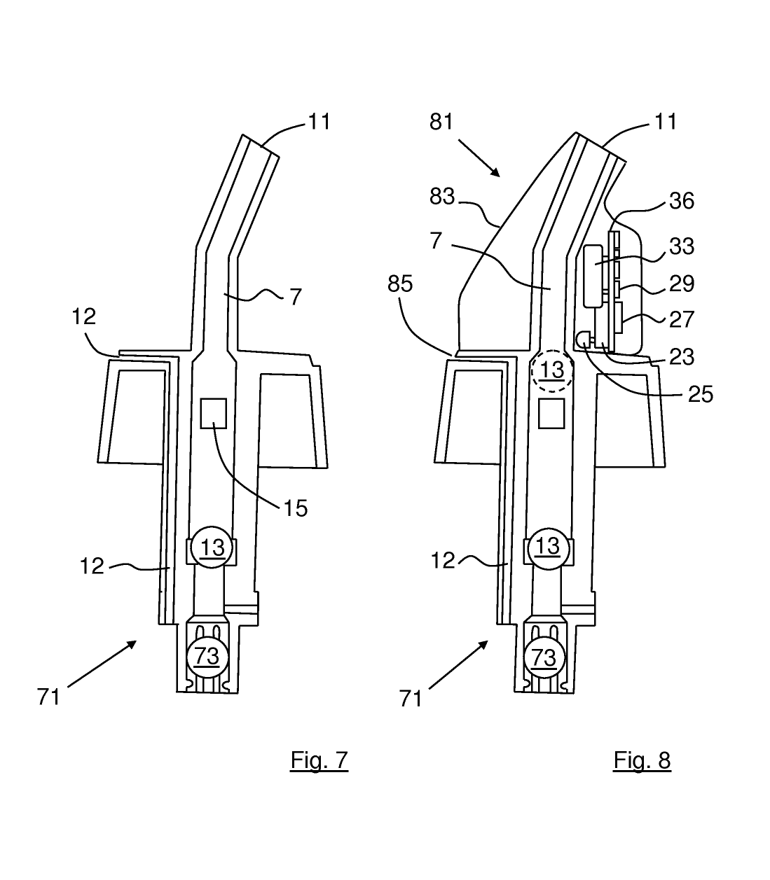

FIG. 7 is a side cross sectional view of a two-ball mechanical portion controller known in the art;

FIG. 8 is a side cross sectional view of a liquid pour metering device according to the present invention mounted on the two-ball mechanical portion controller shown in FIG. 7;

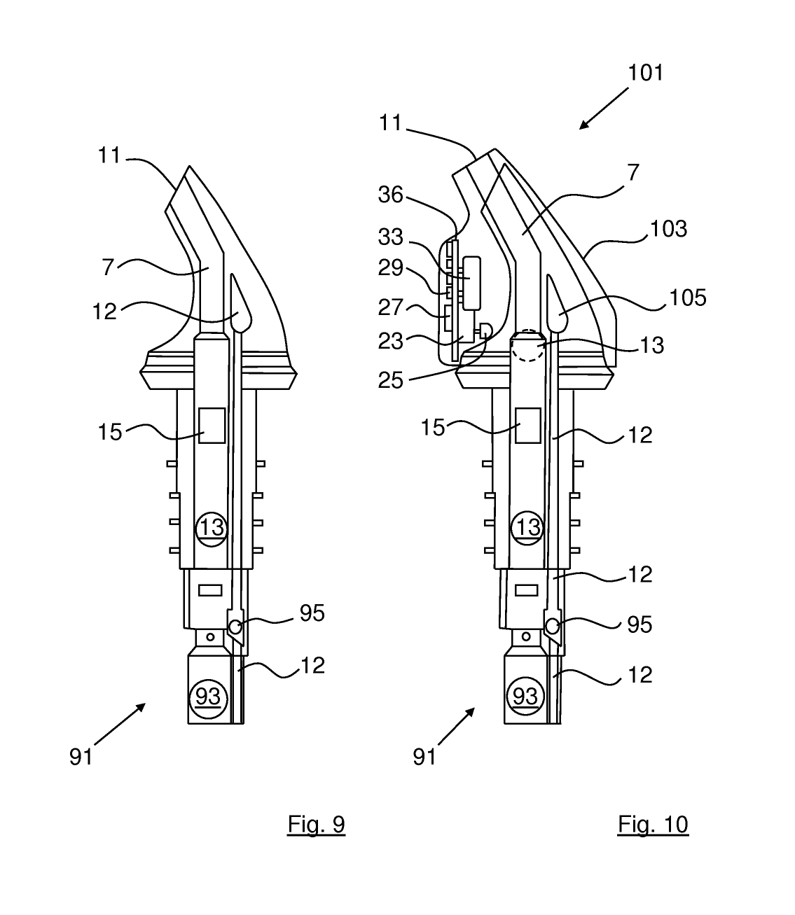

FIG. 9 is a side cross sectional view of a three-ball mechanical portion controller known in the art;

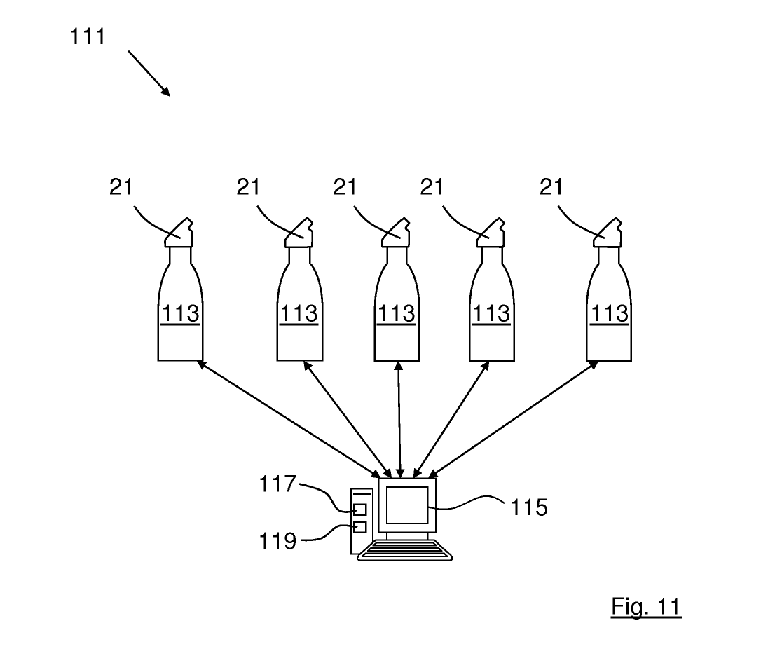

FIG. 10 is a side cross sectional view of a liquid pour metering device according to the present invention mounted on the three-ball mechanical portion controller shown in FIG. 10; and

FIG. 11 is a diagrammatic representation of a liquid pour monitoring system according to the invention.

Referring to FIG. 1, there is shown in cross-sectional view a spout, indicated generally by the reference numeral 1, incorporating a mechanical portion controller (only part of which is shown), indicated generally by the reference numeral 3. The spout 1 comprises a body 5 having a liquid passageway 7 comprising a liquid inlet 9 and a liquid outlet 11, and an air passageway 12. The mechanical portion controller 3 comprises a ball bearing 13 moveable along at least portion of the length of the liquid passageway to and from a first position (as shown) blocking flow of liquid out of the liquid outlet 11 and a second position (shown in outline) permitting flow of liquid out of the liquid outlet 11. The mechanical portion controller further comprises an flow aperture 15 in the liquid passageway 7 providing a second liquid passageway in communication with both the interior of the liquid passageway 7 and the interior of the bottle (not shown) in which the spout 1 is mounted.

In use, the ball bearing 13 sits on a seat (not shown) in the liquid passageway 7 in the second position. In order to pour a liquid from the bottle on which the spout 1 is mounted, the entire bottle including the spout is inverted thereby causing liquid to pass through flow aperture 15 from the interior of the bottle into the liquid passageway 7 and out through the liquid outlet 11. At the same time, the ball bearing 13 travels downwards along the fluid passageway, beyond the flow aperture until it reaches a second seat (not shown) and rests in the position blocking flow of liquid out of the liquid outlet 11. In order to reset the ball bearings, the bottle is returned to the upright position and the ball bearing will gradually fall from the position blocking the flow of liquid out of the liquid outlet 11 to the position permitting flow of liquid out of the liquid outlet 11, ready for another shot to be poured.

For reasons of simplicity, only those parts of the mechanical liquid controller relevant to the understanding of the present invention have been shown in the appended drawings.

Various different types of mechanical portion controllers could be used with the liquid pour metering device according to the present invention including for example those described in U.S. Pat. No. 5,044,521 in the name of Peckels, and U.S. Pat. No. 5,961,008, also in the name of Peckels, as well as variants of the mechanical portion controllers described in those patents. U.S. Pat. No. 5,044,521 illustrates at least one embodiment of two-ball mechanical portion controller and U.S. Pat. No. 5,961,008 illustrated at least one embodiment of three-ball mechanical portion controller. The entire disclosures of those patents and in particular the description relating to the construction and operation of the mechanical portion controllers are incorporated herein by way of reference. In particular, the three ball bearing mechanical portion controller as described in U.S. Pat. No. 5,961,008 and variants thereof are seen as particularly useful controllers for use with the liquid pour metering device according to the present invention. Another type of two ball-bearing spout that could be used with the present invention is that currently produced by the company Posi Pour.

Referring to FIG. 2, where like parts have been given the same reference numerals as before, there is shown a liquid pour metering device, indicated generally by the reference numeral 21. The liquid pour metering device further comprises a motion sensor, in this case a tilt sensor 23, a ball bearing sensor provided by way of an electronic ferrous detection sensor 25, a processor 27 including a timer 29, a transmitter, in this case an RF transmitter 31, and a power supply, in this case a Lithium coin-type battery 33. Instead of the tilt sensor 23, another type of sensor could be used to detect movement and the beginning of a pouring operation, such as, but not limited solely to, an accelerometer. However, the tilt sensor 23 is seen as particularly suitable as it is a simple, inexpensive and reliable device to use. The liquid pour metering device further comprises an end cap 34 for mounting the liquid pour metering device securely on a bottle (not shown). The end cap 34 is provided with an internal screw thread (not shown) for engagement of a complementary screw thread on the neck of a bottle.

In use, when a bartender wishes to pour liquid from the bottle, the bartender upends the bottle to pour liquid from the bottle out through the spout. The tilt sensor 23 senses the bottle being upended and this signal from the tilt sensor 23 is indicative of the commencement of a pour operation. As liquid is poured from the bottle, the ball bearing 13 gradually makes its way along the liquid passageway 7 from a position (shown in outline) permitting flow of liquid out of the liquid outlet 11 to a position (as shown) blocking flow of liquid out of the liquid outlet 11. When the desired amount of liquid has been dispensed, the ball bearing 13 rests in a seat (not shown) in the liquid passageway 7 beyond the flow aperture 15 and blocks further flow of liquid out of the liquid outlet 11. When the ball bearing reaches the seat and blocks the flow of liquid out of the liquid outlet 11, the ball bearing sensor 25 detects the presence of the ball bearing 13 and this is indicative of the end of a pouring operation.

The timer 29 is responsive to signals from both the tilt sensor 23 and the ball bearing sensor 25 and detects the times of pouring operation commencement and pouring operation cessation and from that it is possible to determine the time taken to complete the pouring operation. This data is sent via the transmitter 31 to a remote computer (not shown) for subsequent analysis. From this information, it is possible to determine whether there has been a true pour, an over pour or a non-pour. Under normal operating conditions, the ball bearing 15 should take a predetermined length of time to travel the length of the liquid passageway 7 from the position allowing dispensing of liquid from the liquid outlet 11 to the position preventing dispensing of liquid from the liquid outlet 11. It will be understood that this time may vary depending on the alcoholic beverage and in particular the viscosity of the alcoholic beverage and the size of the flow aperture 15 in particular. It may therefore be necessary to calibrate the device or indeed specify the beverage being dispensed and the specification of the liquid pour metering device 21. If the time taken for the pour is shorter than the expected predetermined length of time, this is indicative that there was no liquid in the bottle and represents a non-pour. If the length of time taken for the pour is longer than the expected predetermined length of time, this is indicative that there was a slow deliberate pour which may have resulted in an overpour. In addition to the above, if the motion sensor detects that the bottle has been tilted but no signal is received from the ball bearing sensor, this is indicative of a short pour and this may be registered as such. In such a case, it may be necessary to determine when the bottle is returned to upright once more and this may be achieved with the same or indeed another motion sensor.

Referring now to FIGS. 3(a) and 3(b), there are shown diagrammatic representations of the electronic circuitry 35 of the liquid pour metering device according to the invention, where like parts have been given the same reference numeral as before. The electronic circuitry comprises printed circuit board (PCB) 36 upon which there is mounted a tilt sensor 23, a ball bearing sensor 25, a processor 27 including a timer 29, an RF transmitter 31, and a battery 33. It can be seen from FIG. 3(b) in particular that when the ball bearing 15 is located in a seat 37, the ball bearing sensor 25 is in close proximity to the ball bearing and can detect the presence of the ball bearing in a relatively unobtrusive manner. In the embodiment shown, there is a maximum separation of approximately 8 mm (0.008 metres) between the ball bearing 13 and the ball bearing sensor 25. In the embodiment shown, the PCB 36 has dimensions of the order of 38 mm by 33 mm (0.038 metres by 0.033 metres).

Referring now to FIGS. 4(a) and 4(b), there are shown diagrammatic representations of an alternative embodiment of electronic circuitry 41 for the liquid pour metering device according to the invention, where like parts have been given the same reference numeral as before. The electronic circuitry 41 advantageously also comprises an optic unit 43 which in turn comprises a roller microswitch 45, and a flowmeter circuit 47 for receiving measurements from a flowmeter (not shown). The flowmeter requires an additional power supply, illustrated by mounting station 49 for a pair of “AAA” batteries (not shown).

By having such a unit, the electronic circuitry 41 can be used with either non-mounted bottles as described in the embodiments above, or may be used to monitor wall mounted bottles or flow of beer, ale, stout, cider, soft drinks or the like from tap units (not shown). In order to detect dispensing of liquid from non-mounted bottles, the circuitry 35 with the ball bearing sensor 25 is used as described above. In order to detect dispensing of liquid from wall mounted bottles, the optic unit 43 is used which in turn uses the microswitch 45 to detect an optic finger lift operation indicative of the dispensing of a liquid from an already inverted wall mounted bottle commonly found in bars. In order to detect dispensing of liquid from a tap, the flowmeter unit 47 is used. In this way, only one electronic circuit board is required as it can be used for any of the three functions and the circuitry will be interchangeable and useable for the required operation. This will facilitate the reduction of manufacturing costs. A universal casing or a plurality of separate casings may be provided to fit the circuitry 41 to any one of the non-mounted bottle, the wall mounted bottle and a tap.

Referring to FIGS. 5 and 6, there are shown a number of views of another embodiment of liquid pour metering device according to the present invention, indicated generally by the reference numeral 51. The liquid pour metering device 51 comprises a casing 53 having a liquid passageway 55, an atmosphere vent passageway 57, a pair of PCB receiving brackets 59, 61 located internal the casing 53 and a plurality of resiliently deformable teeth 63 for gripping the neck of a bottle (not shown). A PCB 36 may be slotted into the pair of PCB receiving brackets 59, 61 to hold the PCB and importantly the ball bearing sensor 25 in position in the casing. The liquid pour metering device 51 is particularly suited for use as a retro-fitted device that may be connected to an existing mechanical portion controller. The PCB is mounted and if desired glued in place in the PCB receiving brackets and the casing is then placed over the spout of a mechanical portion controller with the spout of the mechanical portion controller being inserted into the liquid passageway 55.

Referring to FIG. 7, there is shown a two-ball mechanical portion controller, indicated generally by the reference numeral 71, similar to the one described in detail in U.S. Pat. No. 5,044,521 (Peckels). The two-ball mechanical portion controller 71, as its name suggests, comprises a second ball bearing 73 in addition to the ball bearing 13. Referring to FIG. 8, there is shown an embodiment of liquid pour metering device, indicated generally by the reference numeral 81, where like parts have been given the same reference numeral as before, mounted on the two-ball mechanical controller 71. The liquid pour metering device 81 has a ball bearing sensor 25 configured to detect the ball bearing 13 as it assumes the position blocking the fluid passageway (shown in dashed outline) preventing further flow of liquid out through the liquid passageway 7. The components of the liquid pour metering device 81 are substantially identical to those described with reference to FIG. 2 with the exception of the casing 83. The casing 83 is dimensioned to fit the specific configuration of mechanical portion controller shown and in particular has an air venting passageway 85 that co-operates with the air vent passageway 12 of the two-ball mechanical portion controller 71.

Referring to FIG. 9, there is shown a three-ball mechanical portion controller, indicated generally by the reference numeral 91, similar to the one described in detail in U.S. Pat. No. 5,961,008 (Peckels). The three-ball mechanical portion controller 91, as its name suggests, comprises a second ball bearing 93 and a third ball bearing 95 in addition to the ball bearing 13. The third ball bearing 95 is located in the air venting passageway 12. Referring to FIG. 10, there is shown an embodiment of liquid pour metering device, indicated generally by the reference numeral 101, where like parts have been given the same reference numeral as before, mounted on the three-ball mechanical controller 91. The liquid pour metering device is configured to detect the ball bearing 13 as it assumes the position blocking the fluid passageway (shown in dashed outline) preventing further flow of liquid out through the liquid passageway 7. The components of the liquid pour metering device 101 are substantially identical to those described with reference to FIG. 2 with the exception of the casing 103. The casing 103 is dimensioned to fit the specific configuration of three-ball mechanical portion controller 91 shown and in particular has an air venting passageway 105 that co-operates with the air vent passageway 12 of the three-ball mechanical portion controller 91.

Referring to FIG. 11, there is shown a liquid pour monitoring system, indicated generally by the reference numeral 111, for monitoring dispensing of liquid from a plurality of liquid containers 113, at least some of the liquid containers having a liquid pour metering device 21 as described above. The system 111 comprises a monitoring computer 115 having a receiver 117 to receive the data relating to the length of time required to perform the pour operation from each of the liquid pour metering devices 21 and a processor 119 to process the data. The communications between the liquid pour metering devices 21 and the monitoring computer 115 will preferably be low powered RF communications and the system may incorporate a low powered communications system (not shown) such as a ZigBee network or the like to transmit communications to and or from the monitoring computer and the liquid pour metering devices 21 on each of the bottles 113.

In the embodiments shown, the ball bearing sensor is an electronic ferrous detection sensor, preferably a magnasphere detector. It is envisaged that other sensors could be used such as a capacitive sensor or indeed an optical sensor, pressure switch, flow meter or liquid sensor could be used with suitable modification to the construction of the liquid passageway 7. An infrared sensor or an ultrasonic type sensor could be used to monitor whether or not the ball bearing is in position blocking flow of liquid from the liquid passageway 7. As the cost of these devices decreases, they become more realistic alternative ball bearing sensors. However, the electronic ferrous detection sensor and the capacitive sensor would not require modification to the construction of the liquid passageway and would be seen as particularly useful. By capacitive sensor, what is meant is effectively a pair of metal sheets or conductive sheets separated from each other by a dielectric material. If the permittivity of the dielectric material area between the two sheets changes, as would be caused by the introduction of a ball bearing between the metal sheets, the capacitance of the capacitive sensor will change indicative of the ball bearing 13 being between the two sheets of metal and therefore in the position blocking the flow of liquid through the outlet. The two metal sheets could be placed circumferentially about the liquid passageway diametrically opposed to each other.

In the embodiment shown in FIG. 2, the end cap 34 is provided with an internal screw thread (not shown) for engagement of a complementary screw thread on the neck of a bottle. The screw thread may be a multi-start screw thread. Alternatively, the end cap 34 may be provided with other means of securely engaging the bottle such as a cork or stopper type device and indeed the end cap may be provided with a rubber seal or the like to prevent leakage at the end cap.

In the embodiments described, the analysis of the timing is carried out remotely at the monitoring computer 115 however it is envisaged that an analysis may be carried out locally on the device's processor 27 and thereafter sent to the monitoring computer for logging of the data and subsequent use. The data could be used subsequently in stock taking software to alert the bar manager that a certain number of shots has been dispensed from a particular bottle or indeed that a bottle is in fact empty as determined through the detection of a non-pour.

In this specification the terms “comprise, comprises, comprising and comprised” are all deemed totally interchangeable and the terms “include, includes, included and including are all deemed totally interchangeable and should be afforded the widest possible interpretation.

This invention is in no way limited to the embodiment hereinbefore described but may vary in both construction and detail within the scope of the claims.

1. A liquid pour metering device comprising a body defining a liquid passageway having a liquid inlet at one end and a liquid outlet at the other end, the liquid passageway having a mechanical portion controller therein comprising a ball bearing moveable along at least portion of the length of the liquid passageway to and from a position blocking flow of liquid out of the liquid outlet and a position permitting flow of liquid out of the liquid outlet, characterized in that there is provided a motion sensor to detect when a pour operation has commenced, a ball bearing sensor mounted adjacent the liquid passageway operable to detect when the ball bearing is in the position blocking flow of liquid out of the liquid outlet indicating the end of the pour operation, a timer and a transmitter for transmitting data relating to the length of time required to perform the pour operation.

2. The liquid pour metering device as claimed in claim 1 in which the ball bearing sensor is an electronic ferrous detection sensor.

3. The liquid pour metering device as claimed in claim 2 in which the ball bearing sensor is a Magnasphere® ferrous proximity sensor.

4. The liquid pour metering device as claimed in claim 1 in which the ball bearing sensor is a capacitive sensor.

5. The liquid pour metering device as claimed in claim 1 in which the mechanical portion controller is a two ball bearing mechanical controller.

6. The liquid pour metering device as claimed in claim 1 in which the mechanical portion controller is a three ball bearing mechanical controller.

7. The liquid pour metering device as claimed in claim 1 in which the motion sensor to detect when a pour operation has commenced comprises a tilt sensor.

8. A liquid pour monitoring system for monitoring dispensing of a liquid from a plurality of liquid containers, at least some of the liquid containers having a liquid pour metering device as claimed in claim 1 mounted thereon, the system comprising a monitoring computer having a receiver to receive the data relating to the length of time required to perform the pour operation from each of the liquid pour metering devices and a processor to process the data.

9. A method of monitoring dispensing of liquid from a liquid container, the liquid container having a liquid pour metering device mounted thereon, the liquid pour metering device comprising a body defining a liquid passageway having a liquid inlet at one end and a liquid outlet at the other end, the liquid passageway having a mechanical portion controller therein comprising a ball bearing moveable along at least portion of the length of the liquid passageway to and from a position blocking flow of liquid out of the liquid outlet and hence out of the liquid container and a position permitting flow of liquid out of the liquid outlet and hence out of the liquid container, a motion sensor to detect when a pour operation has commenced, a ball bearing sensor mounted adjacent the liquid passageway operable to detect when the ball bearing is in the position blocking flow of liquid out of the liquid outlet indicating the end of the pour operation, a timer and a transmitter for transmitting data relating to the length of time required to perform the pour operation, the method comprising the steps of:
detecting with the motion sensor when a pour operation has commenced;
detecting with the ball bearing sensor when a pour operation has ceased;
determining the length of time between the pour operation commencing and the pour operation ceasing; and
thereafter determining whether or not the pour was a true pour.

10. The method as claimed in claim 9 in which the method further comprises the step of determining whether the pour was one of an overpour or a non-pour.

11. The method as claimed in claim 9 in which the method further comprises the step of determining whether the pour was a short pour.

12. The method as claimed in claim 9 in which the step of detecting with the ball bearing sensor when a pour operation has ceased comprises using an electronic ferrous detection sensor to detect when the ball bearing is in the position in the liquid passageway blocking flow of liquid out of the liquid outlet.

13. A liquid pour metering device comprising a casing for mounting around a liquid pouring spout, the liquid pouring spout comprising a liquid passageway having a liquid inlet and a liquid outlet, and a mechanical portion controller comprising a ball bearing moveable along at least portion of the length of a liquid passageway in the spout to and from a position blocking flow of liquid out of the liquid outlet and a position permitting flow of liquid out of the liquid outlet, characterized in that the liquid pour metering device comprises, mounted in the casing, a motion sensor to detect when a pour operation has commenced, a ball bearing sensor for mounting adjacent the liquid passageway and operable to detect when the ball bearing is in the position in the liquid passageway blocking flow of liquid out of the liquid outlet indicating the end of the pour operation, a timer and a transmitter for transmitting data relating to the length of time required to perform the pour operation.

14. The liquid pour metering device as claimed in claim 13 in which the ball bearing sensor is an electronic ferrous detection sensor.

15. The liquid pour metering device as claimed in claim 14 in which the ball bearing sensor is a Magnasphere® ferrous proximity sensor.

16. The liquid pour metering device as claimed in claim 13 in which the ball bearing sensor is a capacitive sensor.

17. The liquid pour metering device as claimed in claim 13 in which the motion sensor to detect when a pour operation has commenced comprises a tilt sensor.

18. A liquid pour monitoring system for monitoring dispensing of liquid from a plurality of liquid containers, at least some of the liquid containers having a liquid pour metering device as claimed in claim 12 mounted thereon, the system comprising a monitoring computer having a receiver to receive the data relating to the length of time required to perform the pour operation from each of the liquid pour metering devices and a processor to process the data.
